(19) United States
(12) Patent Application Publication
(10) Pub. No.: US 2022/0384837 A1
(43) Pub. Date: Dec. 1, 2022

(54) ELECTROCHEMICAL SYSTEM COMPRISING SEVERAL FUEL CELLS ELECTRICALLY CONNECTED IN SERIES AND SUPPLIED WITH AIR IN PARALLEL

(71) Applicant: ALSTOM Hydrogène SAS, Aix-En-Provence Cedex (FR)

(72) Inventors: Yacine HAMMADI, Eguilles (FR); Franck VERBECKE, Velaux (FR); Sandrine MELSCOET, Eguilles (FR)

(21) Appl. No.: 17/750,863

(22) Filed: May 23, 2022

(30) Foreign Application Priority Data
May 26, 2021 (FR) 21 05454

(51) Int. Cl. H01M 8/2484; H01M 8/04111

(52) U.S. Cl. CPC H01M 8/2484; H01M 8/04111

(57) ABSTRACT

The electrochemical system includes a plurality of identical fuel cells electrically connected in series and an air supply system configured to supply air to the fuel cells in parallel and to recover air from the fuel cells, the air supply system including an inlet manifold and an outlet manifold each including a common conduit and individual conduits, each individual conduit of the inlet manifold being connected to an air inlet port of a respective fuel cell, each individual conduit of the outlet manifold being connected to an air outlet port of a respective fuel cell and a single air compressor for forcing air to flow through the inlet manifold, the fuel cells and the outlet manifold.

### CROSS-REFERENCE RELATED TO PRIOR APPLICATIONS

This application claims priority to FR 21 05454 filed May 26, 2021, the entire contents of which are hereby incorporated by reference.

### BACKGROUND OF THE INVENTION

### Field of the Invention

The present invention relates to the field of electrochemical systems comprising a plurality of fuel cells using air as oxidiser, the fuel cells being electrically connected in series and supplied with air in parallel.

### Description of the Related Art

A fuel cell is configured to perform a redox reaction between a fuel contained in a fuel fluid and an oxidiser contained in an oxidiser fluid, to produce electrical energy.

The fuel is for example dihydrogen, the fuel fluid being dihydrogen, and the oxidiser is for example dioxygen, the oxidiser fluid being for example dioxygen or air.

A fuel cell comprises at least one electrochemical cell, and preferably a stack of a plurality of superimposed electrochemical cells, each electrochemical cell being configured to carry out the redox reaction between the fuel and the oxidiser.

For applications requiring high electrical power, it is possible to provide an electrochemical system comprising a plurality of identical fuel cells electrically connected in series, the fuel cells being supplied with fuel and oxidiser in parallel.

During the operation of such an electrochemical system, the fuel cells electrically connected in series have the same current flowing through them. Therefore, a uniform and constant supply of oxidiser and fuel to the fuel cells must be ensured so that the fuel cells each generate the same amount of electrical energy.

This can be achieved by equipping a fuel supply system and an oxidiser supply system with sophisticated flow and/or pressure control devices to ensure a uniform supply to the fuel cells.

However, this comes at the cost of increasing the complexity of the electrochemical system, which can lead to relatively high design, manufacturing and operating costs.

### SUMMARY OF THE INVENTION

One of the purposes of the invention is to provide an electrochemical system comprising a plurality of fuel cells using air as an oxidiser, the fuel cells being electrically connected in series and supplied with air in parallel, the electrochemical system being of simple design.

To this end, the invention provides an electrochemical system for the generation of electricity, comprising a plurality of identical fuel cells electrically connected in series and an air supply system configured to supply air to the fuel cells in parallel and recover air from the fuel cells, each fuel cell having an air inlet port and an air outlet port, the air supply system comprising an inlet manifold and an outlet manifold each comprising a common conduit and individual conduits connected to the common conduit, each individual conduit of the inlet manifold being connected to an air inlet port of a respective fuel cell, each individual conduit of the outlet manifold being connected to an air outlet port of a respective fuel cell, and a single air compressor for forcing airflow through the inlet manifold, the fuel cells and the outlet manifold.

The provision of an inlet manifold, an outlet manifold and a single air compressor to force air through the inlet manifold, fuel cells and outlet manifold provides a simple electrochemical system.

The inlet manifold and the outlet manifold allow for a uniform distribution of air between the fuel cells in a passive manner, without the need for an active system of uniform air distribution between the fuel cells.

According to particular embodiments, the electrochemical system comprises one or more of the following features taken individually or in any combination that is technically possible:
at least one of the inlet manifold and the outlet manifold is rotationally symmetrical about an axis of extension of its common conduit;
at least one of the inlet manifold and the outlet manifold is orthogonally symmetrical about at least one plane of symmetry including an axis of extension of its common conduit;
at least one of the inlet manifold and the outlet manifold is orthogonally symmetrical with respect to two distinct planes of symmetry including the axis of extension of its common conduit;
the two planes of symmetry are perpendicular to each other;
at least one of the inlet manifold and the outlet manifold is configured such that the axis of extension of each of its individual conduits is parallel to the axis of extension of its common conduit;
the cross-sectional area of the conduits of at least one of the inlet manifold and the outlet manifold decreases gradually from the common conduit to the individual conduits;
at least one of the inlet manifold and the outlet manifold comprises at least two ramifications between the common conduit and the individual conduits;
each ramification of at least one of the inlet manifold and the outlet manifold divides a conduit into two;
the common conduit of at least one of the inlet manifold and the outlet manifold is branched into two primary conduits, each primary conduit being branched into two secondary conduits;
each secondary conduit is terminated by a respective individual conduit;
it comprises exactly four fuel cells;
the fuel cells are arranged in a matrix arrangement;
the fuel cells are all arranged in the same orientation;
the inlet and outlet manifolds are identical.

### BRIEF DESCRIPTION OF THE DRAWINGS

The invention and its benefits will become apparent upon reading the following description, given only as a non-limiting example, with referring to the attached drawings, in which:

FIG. 1 is a schematic view of an electrochemical system comprising a plurality of fuel cells;

FIG. 2 is a schematic view of the electrochemical system showing the arrangement of the fuel cells, an inlet manifold and an outlet manifold;

FIG. 3 is a perspective view of the inlet manifold;

FIG. 4 is a perspective view of the outlet manifold; and

FIG. 5 is a schematic cross-section view of a primary ramification of an inlet manifold.

### DETAILED DESCRIPTION OF PREFERRED EMBODIMENTS

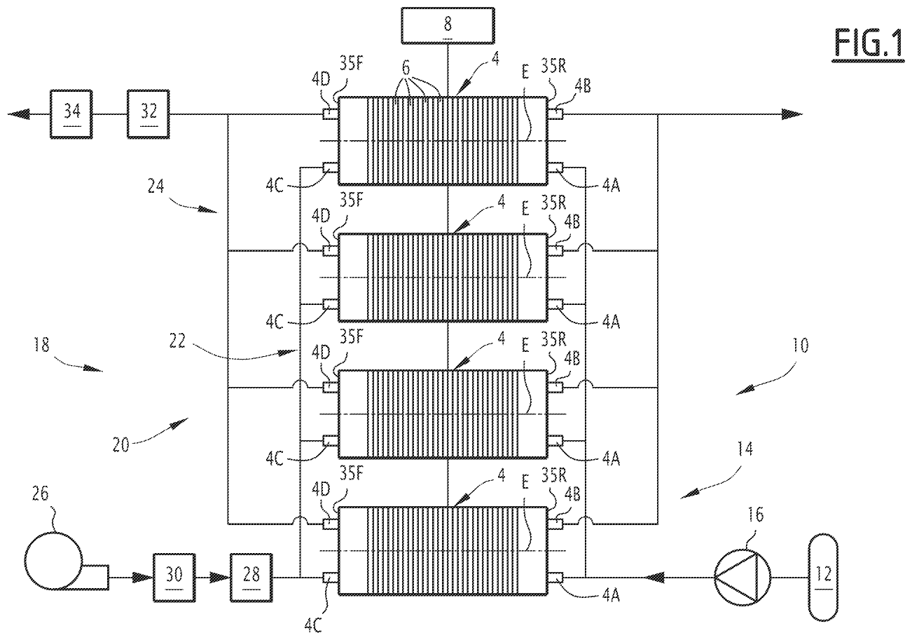

As illustrated in FIG. 1, the electrochemical power generation system 2 comprises a plurality of identical fuel cells 4, each fuel cell 4 comprising a stack of a plurality of electrochemical cells 6 superimposed on top of each other.

Each fuel cell 4 extends along a central axis E, for example, with the electrochemical cells 6 superimposed along this central axis E.

Each electrochemical cell 6 is configured to generate electricity by carrying out a redox reaction between a fuel contained in a fuel fluid and an oxidiser contained in an oxidiser fluid.

Each fuel cell 4 is, for example, an ion exchange membrane fuel cell, in particular a proton exchange membrane fuel cell (PEMFC).

In a known manner, each electrochemical cell 6 comprises a first chamber for the circulation of the fuel fluid and a second chamber for the circulation of the oxidiser fluid, the first chamber and the second chamber being separated by an ion exchange membrane, in particular a proton exchange membrane.

Each fuel cell 4 is configured, for example, to use hydrogen (H2) as fuel, the fuel medium being, for example, hydrogen.

Each fuel cell 4 is configured to use air as the oxidiser fluid, the oxidiser being the oxygen present in the air.

Each fuel cell 4 comprises a fuel fluid inlet port 4A for the entry of fuel fluid into the fuel cell 4 and the supply of fuel fluid to each electrochemical cell 6, and a fuel fluid outlet port 4B for the exit of fuel fluid after passing through the electrochemical cells 6 of the fuel cell 4.

Each fuel cell 4 comprises an air inlet port 4C for the entry of air into the fuel cell 4 and the supply of air to each electrochemical cell 6, and an air outlet port 4D for the exit of air after it has passed through the electrochemical cells 6 of the fuel cell 4.

The fuel cells 4 are electrically connected in series. Thus, during operation, the same electric current flows through the fuel cells 4.

The fuel cells 4 are, for example, connected to an electrical load 8 to supply electricity to this electrical load 8. The electrical load 8 comprises for example batteries for storing electricity or an electric motor.

The electrochemical system 2 comprises a fuel fluid supply system 10 comprising a fuel fluid source 12.

The fuel fluid supply system 10 comprises a fuel fluid circuit 14 connecting the fuel fluid inlet ports 4A of the fuel cells 4 to the fuel fluid source 12, preferably in parallel.

The fuel fluid system 14 comprises, for example, a pump 16 arranged to force fuel fluid to flow through the fuel fluid system 14. The pump 16 is arranged for example between the fuel fluid source 12 and the fuel fluid inlet ports 4A of the fuel cells 4.

The electrochemical system 2 comprises an air supply system 18 configured to supply air to the fuel cells 4.

The air supply system 18 comprises an air circuit 20, with the fuel cells 4 arranged in parallel in the air circuit 20.

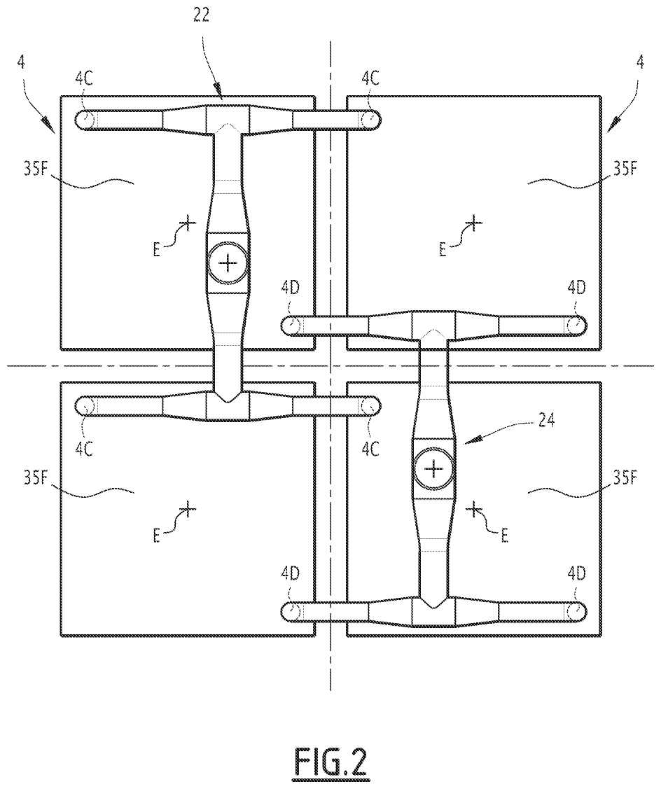

The air supply system 18 comprises an inlet manifold 22 (FIG. 2) configured to distribute an incoming airflow between the air inlet ports 4C of the fuel cells 4, and an outlet manifold 24 (FIG. 2) configured to collect air exiting the air outlet ports 4D of the fuel cells 4 to form an outgoing airflow.

The inlet manifold 22 and the outlet manifold 24 are each in the form of a manifold for passively conducting the airflow upstream of the fuel cells 4 and downstream of the fuel cells 4 respectively.

The inlet manifold 22 and the outlet manifold 24 are devoid of any active airflow regulator with an actuator to actively regulate the airflow.

The air supply system 18 comprises a single air compressor 26 arranged to force air through the fuel cells 4 via the inlet manifold 22 and the outlet manifold 24, specifically, in series through the inlet manifold 22, the fuel cells 4 and the outlet manifold 24.

Preferably, the air compressor 26 is arranged in the air circuit 20 upstream of the inlet manifold 22. The air compressor 26 pushes air into the inlet manifold 22, the fuel cells 4 and the outlet manifold 24.

The air compressor 26 generates the incoming airflow which feeds the fuel cells 4 in parallel via the inlet manifold 22. The outlet manifold 24 collects the air leaving the fuel cells 4 to form the outgoing airflow.

Optionally, the air supply system 18 comprises at least one air filtering device 28 configured to filter the air before it enters the fuel cells 4.

Preferably, the air supply system 18 comprises a single air filtering device 28 which is arranged upstream of the inlet manifold 22. Thus, a single air filtering device 28 can filter the air supplied to a plurality of fuel cells 4.

Advantageously, the air filtering device 28 is arranged downstream of the air compressor 26.

Optionally, the air supply system 18 comprises at least one cooling device 30 configured to cool the air before it enters the fuel cells 4. This allows the air heated by the compression to be cooled before it enters the fuel cells 4.

Preferably, the air supply system 18 comprises a single cooling device 30 arranged between the air compressor 26 and the inlet manifold 22.

When an air filtering device 28 is provided, the cooling device 30 is preferably arranged upstream of the air filtering device 28. This helps protect the air filtering device 28 by limiting its exposure to heat.

Optionally, the air supply system 18 comprises, for example downstream of the outlet manifold 24, a regulating device 32 configured to regulate the flow of air into the fuel cells 4.

The regulating device 32 comprises, for example, a movable valve so as to decrease or increase a cross-sectional area of the airflow.

Preferably, the air supply system 18 comprises a vent 34 for discharging air into the atmosphere after it has passed through the fuel cells 4. The vent 34 is located downstream of the outlet manifold 24, and, if applicable, the regulating device 32.

In FIG. 1, the fuel cells 4 are shown schematically in side view and aligned next to each other to illustrate the fuel fluid supply system 10 and the air supply system 18.

As shown in FIG. 2, the fuel cells 4 are preferably arranged next to each other in a three-dimensional configuration.

The fuel cells 4 are, for example, arranged in a matrix configuration, in which the fuel cells 4 are arranged in rows and columns, or a circular configuration, in which the fuel cells 4 are distributed along an imaginary circle.

This allows the fuel cells 4 to be arranged in such a way as to facilitate their being uniformly supplied with air.

In a particularly advantageous embodiment, as shown in FIG. 2 in which the fuel cells 4 are shown in front view, the fuel cells are four in number and arranged in a 2×2 matrix arrangement.

The fuel cells 4 are, for example, arranged in such a way that, in a front view of the fuel cells 4, their central axes E are arranged at the four corners of an imaginary square.

The fuel cells 4 are preferably arranged so that their central axes E are parallel to each other.

Each fuel cell 4 has a front face 35F and a rear face 35R located at the ends of the fuel cell 4 along the central stacking axis E of the electrochemical cells 6.

The fuel cells 4 are preferably arranged so that their front faces 35F face the same direction and their rear faces 35R face the same direction.

The front faces 35F of the fuel cells 4 are preferably arranged in one plane (the plane in FIG. 2).

The air inlet ports 4C of the fuel cells 4 are for example located on the front faces 35F of the fuel cells 4.

The fuel cells 4 are preferably arranged in the same orientation around their respective stacking axes E.

In the illustrated example, the front face 35F of each fuel cell 4 has a rectangular outline, each fuel cell 4 being oriented about its stacking axis E such that the edges of the front face 35F are parallel to the row and column directions of the fuel cell 4 matrix arrangement, the air inlet port 4C of each fuel cell 4 being located in the upper left corner of the front face 35F.

In a preferred embodiment, the fuel cell air outlet ports 4D are also located on the front faces 35F of the fuel cells 4.

When the front face 35F of each fuel cell 4 is rectangular in shape, the air inlet port 4C and the air outlet port 4D are for example each located in a respective corner of the front face 35F, in particular in two diagonally opposite corners.

As shown in FIG. 2, the air outlet port 4D of each fuel cell 4 is located, for example, in the lower right-hand corner of the front face 35F of the fuel cell 4.

The inlet manifold 22 (also known as the “distributor”) is configured to distribute the airflow generated by the air compressor 26 between the air inlet ports 4C of the fuel cells 4 in a uniform manner.

The inlet manifold 22 comprises a common conduit 36 and a plurality of individual conduits 38 connected to the common conduit 36, each individual conduit 38 being connected to the air inlet port 4C of a respective fuel cell 4.

Considering the direction of airflow, the common conduit 36 gradually divides to form the individual conduits of the inlet manifold 22.

The inlet manifold 22 comprises a respective individual conduit 38 for each fuel cell 4. The air inlet port 4C of each fuel cell 4 is connected to a respective individual conduit 38 of the inlet manifold 22.

The common conduit 36 of the inlet manifold 22 extends along a common extension axis A and each individual conduit 38 of the inlet manifold 22 extends along a respective individual extension axis B.

In one embodiment, the individual extension axes B of the individual conduits 38 are parallel to the common extension axis A of the common conduit 36.

Advantageously, the inlet manifold 22 has discrete rotational symmetry about the common extension axis A of its common conduit 36.

The inlet manifold 22 is rotationally symmetrical of order n about the extension axis A of its common conduit 36, where n is a positive integer. The inlet manifold 22 is in this case invariant by rotation about the common extension axis A of its common conduit 36 by an angle of 2π/n.

The inlet manifold 22 is for example orthogonally symmetrical with respect to at least one plane of symmetry including the common extension axis A of the common conduit 36.

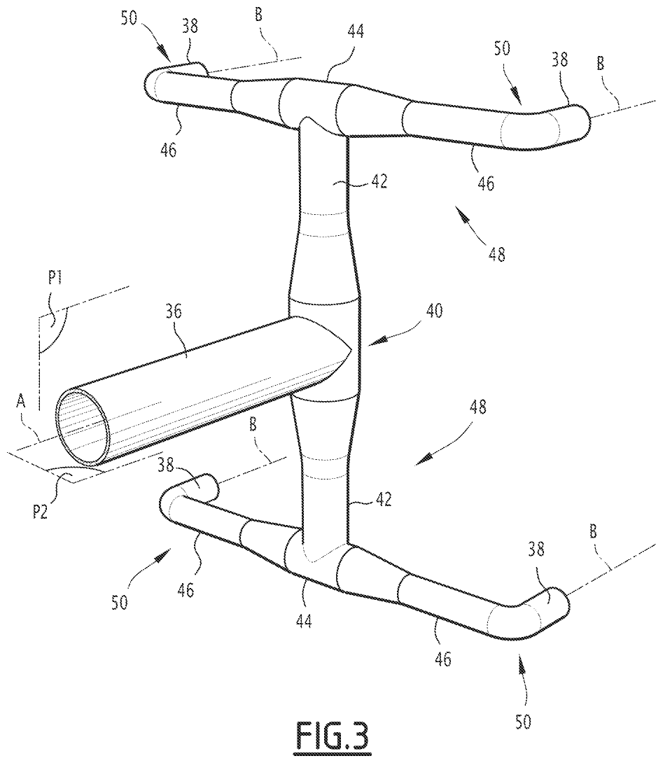

In a particular embodiment, as illustrated in FIG. 3, the inlet manifold 22 is orthogonally symmetrical with respect to two distinct planes of symmetry P1, P2 each including the common extension axis A of the common conduit 36, the two planes of symmetry P1 and P2 preferably being perpendicular to each other.

The inlet manifold 22 comprises for example at least two ramifications between the common conduit 36 and the individual conduits 38. For example, each ramification divides an upstream conduit into two downstream conduits.

As illustrated in FIG. 3, the inlet manifold 22 is for example configured with its common conduit 36 subdivided at a primary ramification 40 into two primary conduits 42, each primary conduit 42 in turn being branched at a secondary ramification 44 into two secondary conduits 46. Each secondary conduit 46 is for example terminated by a respective individual conduit 38.

Such an inlet manifold 22 thus comprises four individual conduits 38. It is configured for an electrochemical system 2 comprising four fuel cells 4 as shown in FIG. 2.

The inlet manifold 22 comprises two manifold portions 48 each extending from the primary ramification 40, each of the two manifold portions 48 being symmetrical to the other about the plane of symmetry P1.

Each manifold portion 48 includes a respective secondary ramification 44 and two manifold sub-portions 50 extending from the secondary ramification 44, each of the two manifold sub-portions 50 being symmetrical to the other about the plane of symmetry P2.

Preferably, the cross-sectional area of the inlet manifold conduits gradually decreases from the common conduit 36 to the individual conduits 38.

In particular, the cross-sectional area of the inlet manifold conduits 22 gradually decreases after each ramification (e.g. primary ramification 40 and secondary ramification 44), moving from the common conduit 36 to the individual conduits 38.

In the example shown, the cross-sectional area of the conduits gradually decreases along the primary conduits 42 and the secondary conduits 46. Each primary conduit 42 and each secondary conduit 46 has a cross-sectional area with gradually decreasing area.

Considering the direction of airflow, the cross-sectional area of the inlet manifold conduits 22 decreases gradually from upstream (common conduit 36) to downstream (individual conduits 38).

The reduction in cross-sectional area of each conduit of the inlet manifold 22 is achieved over the entire length of the conduit or over a fraction of the length of the conduit.

In the example shown in FIG. 3, the reduction in cross-sectional area of the primary conduits 42 and secondary conduits 46 is achieved over a fraction of the length of these conduits.

The outlet manifold 24 is also configured to provide an even distribution of air between the fuel cells 4.

To do this, it is configured to combine the separate airflows exiting from the air outlet ports 4D of the fuel cells 4 into a common outlet airflow, ensuring identical flow conditions for the different separate airflows.

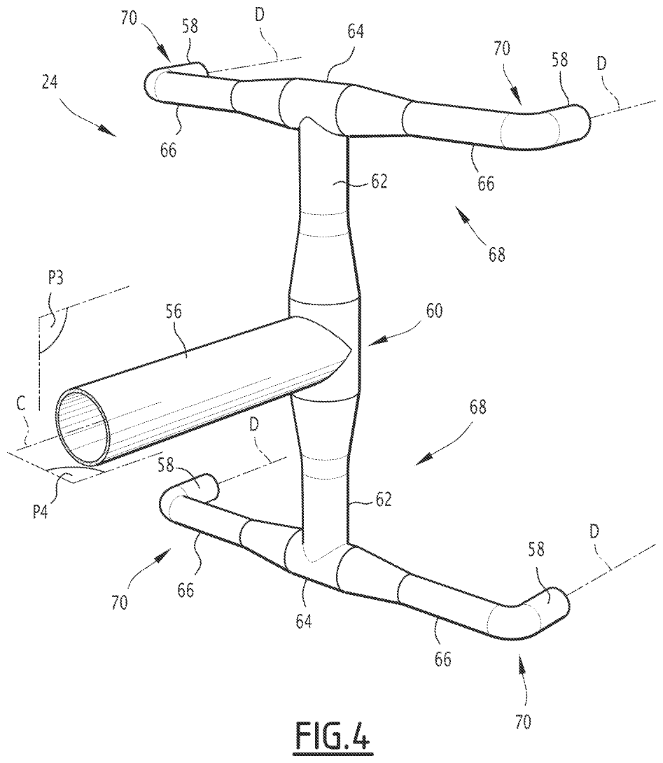

For this purpose, as shown in FIG. 4, the outlet manifold 24 is for example analogous to the inlet manifold 22.

The outlet manifold 24 comprises a common conduit 56 and a plurality of individual conduits 58 connected to the common conduit 56, each individual conduit 58 being connected to the air outlet port 4D of a respective fuel cell 4.

Considering the direction of airflow, the individual conduits 58 of the outlet manifold 24 merge to form the common conduit 56 of the outlet manifold 24.

The outlet manifold 24 comprises a respective individual conduit 58 for each fuel cell 4. The air outlet port 4D of each fuel cell 4 is connected to a respective individual conduit 58 of the outlet manifold 24.

The common conduit 56 of the outlet manifold 24 extends along a common extension axis A and each individual conduit 58 of the outlet manifold 24 extends along a respective individual extension axis B.

In one embodiment, the individual extension axes D of the individual conduits 58 of the outlet manifold 24 are parallel to the common extension axis C of the common conduit 56 of the outlet manifold 24.

Advantageously, the outlet manifold 24 has discrete rotational symmetry about the common extension axis A of its common conduit 56.

The outlet manifold 24 is rotationally symmetrical of order n about the common extension axis C of its common conduit 56. The outlet manifold 24 is in this case invariant by rotation about the common extension axis C of its common conduit 56 by an angle of 2π/n.

The outlet manifold 24 is for example orthogonally symmetrical with respect to at least one plane of symmetry including the common extension axis C of the common conduit 56.

In a particular embodiment, as illustrated in FIG. 4, the outlet manifold 24 is orthogonally symmetrical with respect to two distinct planes of symmetry P3, P4 each including the common extension axis C of the common conduit 56, the two planes of symmetry P3, P4 preferably being perpendicular to each other.

The outlet manifold 24 comprises for example at least two ramifications between the common conduit 56 and the individual conduits 58. For example, each ramification divides an upstream conduit into two downstream conduits.

As illustrated in FIG. 4, the outlet manifold 24 is for example configured with its common conduit 56 subdivided at a primary ramification 60 into two primary conduits 62, each primary conduit 62 in turn being branched at a secondary ramification 64 into two secondary conduits 66. Each secondary conduit 66 is for example terminated by a respective individual conduit 58.

Such an outlet manifold 24 thus comprises four individual conduits 58. It is configured for an electrochemical system 2 comprising four fuel cells 4 as shown in FIG. 2.

The outlet manifold 24 comprises two manifold portions 68 each extending from the primary ramification 60, each of the two manifold portions 68 being symmetrical to the other about the plane of symmetry P4.

Each manifold portion 68 includes a respective secondary ramification 64 and two manifold sub-portions 70 extending from the secondary ramification 64, each of the two manifold sub-portions 70 being symmetrical to the other about the plane of symmetry P3.

Preferably, the cross-sectional area of the outlet manifold conduits 24 gradually decreases from the common conduit 56 to the individual conduits 58.

In particular, the cross-sectional area of the outlet manifold conduits 24 gradually decreases after each ramification (e.g. primary ramification 60 and secondary ramification 64), moving from the common conduit 56 to the individual conduits 58.

Considering the direction of airflow, the cross-sectional area of the conduits of the outlet manifold 24 increases from upstream (individual conduits 58) to downstream (common conduit 56).

In the example shown, the cross-sectional area of the conduits gradually decreases along the primary conduits 62 and the secondary conduits 66. Each primary conduit 62 and each secondary conduit 66 has a cross-sectional area with gradually decreasing area.

The reduction in cross-sectional area of each conduit of the outlet manifold 24 is achieved over the entire length of the conduit or over a fraction of the length of the conduit.

In the example shown in FIG. 4, the reduction in cross-sectional area of the primary conduits 62 and secondary conduits 66 is achieved over a fraction of the length of these conduits.

As illustrated in FIGS. 3 and 4, each ramification (primary ramification 40 and secondary ramification 46 of the inlet manifold 22, primary ramification 60 and secondary ramification 64 of the outlet manifold 24) is generally T-shaped.

Alternatively, at least one or each of the ramification between a first conduit and two second conduits extending from the second conduit is Y-shaped.

This avoids the occurrence of localised overpressure which can lead to non-uniformity of airflow in the different conduits at the same level of a manifold (inlet manifold 22 or outlet manifold 24).

The two second conduits can be angled.

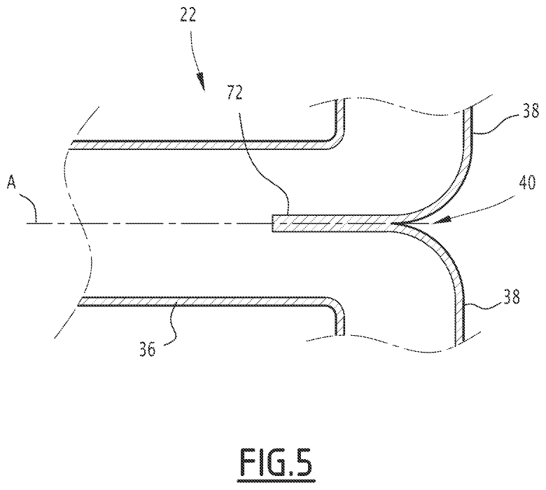

As shown in FIG. 5, the common conduit 36 (first conduit) of an inlet manifold 22 divides at a primary ramification 40 into two primary conduits 42 (second conduits), the primary ramification 40 being Y-shaped. The primary conduits 42 are angled.

FIG. 5 illustrates by way of example the case of a primary ramification 40 of the inlet manifold 22, but this may of course apply to a primary ramification 60 of the outlet manifold 24 and/or to each secondary ramification 44 of the inlet manifold 22 and/or to each secondary ramification 64 of the outlet manifold 24.

Ramifications of the same level (secondary ramification, possible tertiary ramification, etc.) of a manifold preferably have the same type of shape, in order to ensure a uniform flow between the different fuel cells 4.

In a four fuel cell example 4 with an inlet manifold 22 having secondary ramifications 44, these secondary ramifications 44 have the same shape (e.g. T or Y).

In a four fuel cell example 4 with an outlet manifold 24 having secondary ramifications 64, these secondary ramifications 64 have the same shape (e.g. T or Y).

Optionally, at least one or each ramification dividing a first conduit into two second conduits has an intermediate partition extending into the first conduit from the ramification, the intermediate partition dividing the first conduit into two parts symmetrical to the intermediate partition.

This prevents turbulence at the junction between the two second conduits and improves the uniformity of the airflow between the two second conduits.

As illustrated in FIG. 5, the primary ramification 40 of the inlet manifold 22 is provided with an intermediate partition 72 extending into the common conduit 38 separating it into two symmetrical parts on either side of the intermediate partition 72 upstream of the primary conduits 42.

FIG. 5 illustrates by way of example the case of a primary ramification 40 of the inlet manifold 22, but this may of course apply to a primary ramification 60 of the outlet manifold 24 and/or to each secondary ramification 44 of the inlet manifold 22 and/or to each secondary ramification 64 of the outlet manifold 24.

If a ramification of a manifold (inlet manifold 22 or outlet manifold 24) has an intermediate wall, then the other ramifications on the same level as that manifold also have an intermediate wall.

In particular, when one secondary ramification 44 of the inlet manifold 22 has an intermediate partition 72, the other secondary ramification 44 of that inlet manifold 22 also has one, and when one secondary ramification 64 of the outlet manifold 24 has an intermediate partition 72, the other secondary ramification 64 of that outlet manifold 24 also has one.

In one embodiment, the electrochemical system 2 has a nominal/maximum output of between 150 and 350 kW. Each fuel cell 4 has a nominal/maximum output of between 40 and 100 kW.

Preferably, the air compressor 26 has a nominal/maximum flow rate of between 250 and 600 g/sec.

The electrochemical system 2 can be configured for stationary use, for example as a main or auxiliary source of electrical power for a building, or for mobile use, for example as an on-board source of electrical power in a road vehicle, for example a passenger car, public transport vehicle or heavy goods vehicle, a rail vehicle or an air vehicle.

By means of the invention, it is possible to obtain a simple electrochemical system 2 for supplying air in parallel to a plurality of fuel cells 4 connected electrically in series.

The provision of an inlet manifold 22 and an outlet manifold 24 allows for a uniform distribution of air between the fuel cells 4 from an incoming airflow supplied by a single air compressor 26, so that the fuel cells, with the same current flowing through them, can operate under the same conditions.

The characteristics of the inlet manifold 22 and the outlet manifold 24, in particular their discrete rotational symmetry or orthogonal symmetry(s) with respect to one or more planes of symmetry (P1, P2; P3, P4), allow for a uniform distribution of the air within each manifold.

The optimal layout of the fuel cells 4 facilitates the provision of an inlet manifold 22 and/or an outlet manifold 24 with such symmetry(s) as to promote uniform air distribution between the fuel cells 4.

The use of a single air compressor 26 simplifies the air supply system 18.

It is possible to achieve an electrochemical power generation system 2 that has a high power output, yet is simple in design.

In addition, the air compressor 26 is one of the components of an electrochemical system that has lower reliability than the other components. The use of a single air compressor 26 instead of multiple air compressors simplifies operation and also improves reliability and simplifies maintenance.

The inlet manifold 22 and the outlet manifold 24 are preferably similar and have, for example, each of the characteristics indicated above.

However, it is possible that either the inlet manifold 22 or the outlet manifold 24 has a characteristic that the other does not.

In general, for each of the characteristics described above, at least one of the inlet manifold 22 and the outlet manifold 24 has said characteristic. In other words, the inlet manifold 22 and/or the outlet manifold 24 each have characteristics.

The invention is not limited to the embodiments shown, as other embodiments are possible.

In particular, the number of fuel cells 4 in the power generation system 2 is not necessarily equal to four. It can be for example two, three or more than four.

1. An electrochemical system for the generation of electricity, comprising a plurality of identical fuel cells electrically connected in series and an air supply system configured to supply air to the fuel cells in parallel and recover air from the fuel cells, each fuel cell having an air inlet port and an air outlet port, the air supply system comprising an inlet manifold and an outlet manifold each comprising a common conduit and individual conduits connected to the common conduit, each individual conduit of the inlet manifold being connected to an air inlet port of a respective fuel cell, each individual conduit of the outlet manifold being connected to an air outlet port of a respective fuel cell, and a single air compressor for forcing air to flow through the inlet manifold, the fuel cells and the outlet manifold.

2. The electrochemical system according to claim 1, wherein at least one of the inlet manifold and the outlet manifold is rotationally symmetrical about an axis of extension of its common conduit.

3. The electrochemical system according to claim 1, wherein at least one of the inlet manifold and the outlet manifold is orthogonally symmetrical about at least one plane of symmetry including an axis of extension of its common conduit.

4. The electrochemical system according to claim 1, wherein at least one of the inlet manifold and the outlet manifold is orthogonally symmetrical with respect to two distinct planes of symmetry including the axis of extension of its common conduit.

5. The electrochemical system according to claim 4, wherein the two planes of symmetry are perpendicular to each other.

6. The electrochemical system according to claim 1, wherein at least one of the inlet manifold and the outlet manifold is configured such that the axis of extension of each of its individual conduits is parallel to the axis of extension of its common conduit.

7. The electrochemical system according to claim 1, wherein the cross-sectional area of the conduits of at least one of the inlet manifold and the outlet manifold decreases gradually from the common conduit towards the individual conduits.

8. The electrochemical system according to claim 1, wherein at least one of the inlet manifold and the outlet manifold comprises at least two ramifications between the common conduit and the individual conduits.

9. The electrochemical system according to claim 8, wherein each ramification of at least one of the inlet manifold and the outlet manifold divides a conduit into two.

10. The electrochemical system according to claim 1, wherein the common conduit of at least one of the inlet manifold and the outlet manifold is branched into two primary conduits, each primary conduit being branched into two secondary conduits.

11. The electrochemical system according to claim 10, wherein each secondary conduit is terminated by a respective individual conduit.

12. The electrochemical system according to claim 1, comprising exactly four fuel cells.

13. The electrochemical system according to claim 1, wherein the fuel cells are arranged in a matrix arrangement.

14. The electrochemical system according to claim 13, wherein the fuel cells are all arranged in the same orientation.

15. The electrochemical system according to claim 1, wherein the inlet manifold and the outlet manifold are identical.
